(19) United States
(12) Patent Application Publication
(10) Pub. No.: US 2004/0179098 A1
(43) Pub. Date: Sep. 16, 2004

(54) Image reversing for infrared camera

(76) Inventors: Craig S. Haehn, Avon Lake, OH (US); Mark A. Matko, North Olmsted, OH (US); Duane R. Johnson, Wellington, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/373,925

(22) Filed: Feb. 25, 2003

(51) Int. Cl. H04N 7/18

(52) U.S. Cl. 348/148

(57) ABSTRACT

An apparatus for displaying an image of an area outside a vehicle includes a camera for mounting on the vehicle at a location adapted for taking an image of an area outside the vehicle. The apparatus also includes a mirror for mounting on the vehicle at a location between the camera and the area being imaged whereby the image of the area is reversed in a left to right direction when received at the camera. The apparatus further includes an electronic display device having a display area for displaying the reversed image.

### BACKGROUND OF THE INVENTION

The present invention relates to imaging and image displays. In particular, the present invention relates to a system for taking an image of an area outside a vehicle and for displaying the image to the driver of the vehicle.

It is known to use video cameras and/or infrared cameras to take images of the area around a vehicle, such as a car or a truck. The images can be displayed on a video screen or other display device on the instrument panel of the vehicle, for viewing by the driver of the vehicle. One problem that has been discovered with regard to such image displays is that they are the reverse of what a driver would normally see in a rear-view mirror; this can be confusing to the driver.

### SUMMARY OF THE INVENTION

The present invention in one embodiment relates to an apparatus for displaying an image of an area outside a vehicle. The apparatus includes a camera for mounting on the vehicle at a location adapted for taking an image of an area outside the vehicle. The apparatus also includes a mirror for mounting on the vehicle at a location between the camera and the area being imaged whereby the image of the area is reversed in a left to right direction when received at the camera. The apparatus further includes an electronic display device having a display area for displaying the reversed image.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic illustration of a vehicle including an image taking and display system in accordance with one embodiment of the invention;

FIG. 2 is a perspective view of a camera and mirror assembly that forms part of the system of FIG. 1;

FIG. 3 is an exploded perspective view of the camera and mirror assembly of FIG. 2;

FIG. 4 is a longitudinal sectional view of the camera and mirror assembly of FIG. 2; and

FIG. 5 is a radial sectional view taken generally along line 5-5 of FIG. 4.

### DETAILED DESCRIPTION OF THE INVENTION

The present invention relates to imaging and image displays and, in particular, to a system for taking an image of an area outside a vehicle and displaying the image to the driver of the vehicle. The present invention is applicable to image taking and display systems of varying constructions. As representative of the present invention, FIG. 1 illustrates schematically an image taking and display system 10 in accordance with one embodiment of the invention.

The system 10 is illustrated as being installed on a vehicle 12. A forward direction of travel of the vehicle is indicated by the arrow 14; an opposite rearward direction is indicated by the arrow 16.

The system 10 includes three imagers, or cameras. It should be understood that the invention is applicable to systems having a different number of cameras, for example, as few as one or two cameras, or four cameras or more.

The three cameras in the illustrated system 10 include a front camera 18 mounted on the vehicle 12 in a location adapted to take an image of a front area outside the vehicle. A left rear camera 20 is mounted on the vehicle 12 in a location adapted to take an image of a left rear area outside the vehicle. A right rear camera 22 is mounted on the vehicle 12 in a location adapted to take an image of a right rear area outside the vehicle.

Each one of the cameras 18-22 in the illustrated embodiment is an infrared camera. It should be understood that the present invention is applicable for use with other types of cameras, for example, visible light cameras, thermal cameras, and other cameras. The cameras 18-22 may be the same as each other or may be different from each other.

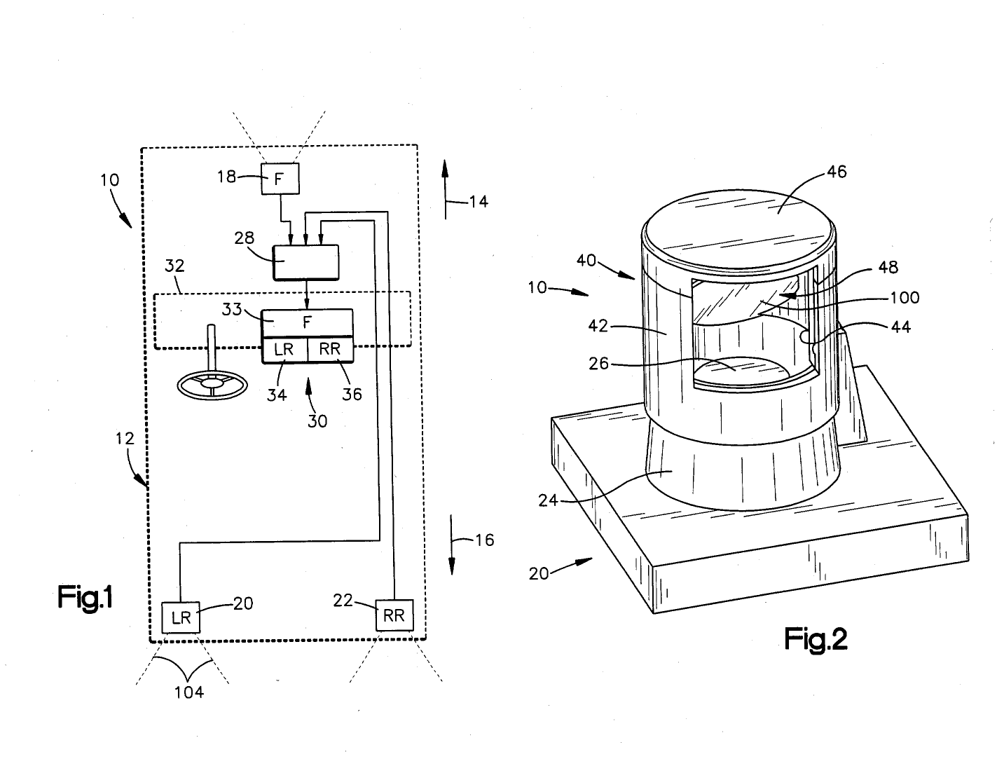

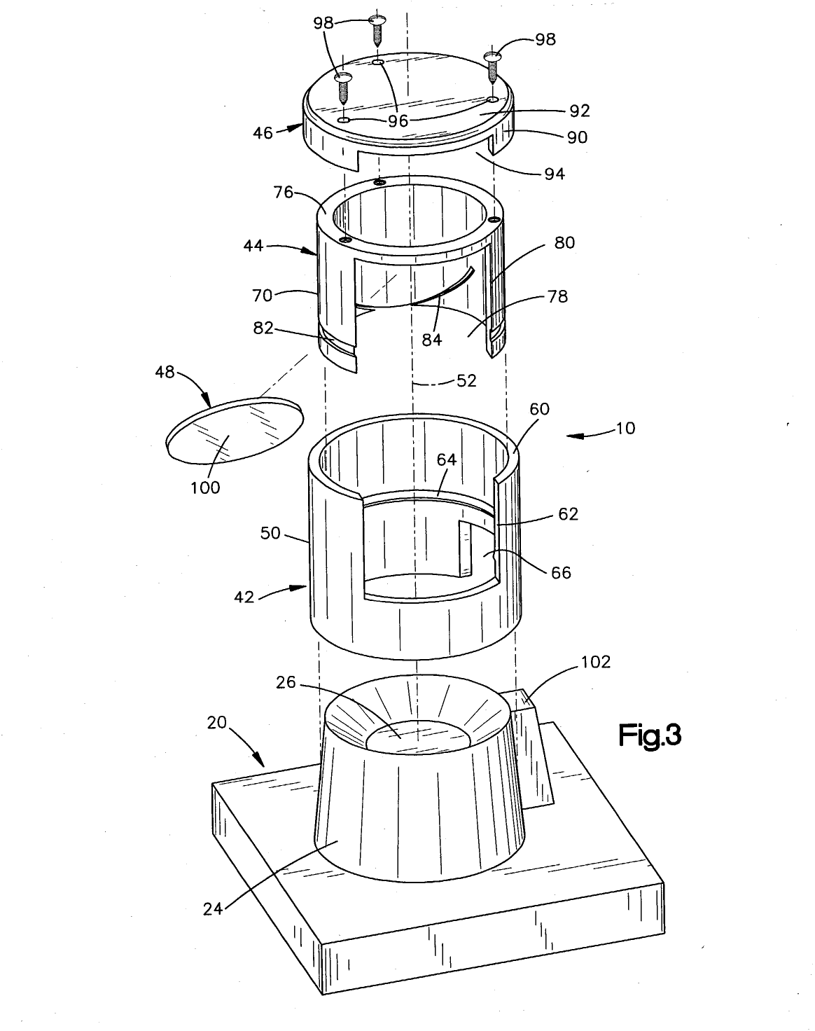

Each one of the cameras 18-22, as shown schematically in FIGS. 2-5, has a housing portion 24 that supports a window 26 of the camera. The window 26 is the portion of the camera 18-22 through which the infrared energy enters the camera.

Each one of the cameras 18-22 is operative to take an image of its respective outside area and to output that image, via electric circuitry indicated schematically at 28, to an image display apparatus 30. The image display apparatus 30 is located within the field of vision of the driver of the vehicle 12. One suitable location is the instrument panel 32 of the vehicle 12, although other locations are possible.

In the illustrated embodiment, the image display apparatus 30 is an LCD screen. Other display devices are possible. The LCD screen 30 is electronically controlled by the circuitry 28. The circuitry 28 is operative to display three different images on the screen 30, simultaneously, in three different areas of the screen.

Specifically, the screen 30 has three display areas—a front display area 33, a left rear display area 34, and a right rear display area 36. The front display area 33 is operative to display an image of the front area of the vehicle 12. The left rear display area 34 is operative to display an image of the left rear area of the vehicle 12. The right rear display area 36 is operative to display an image of the right rear area of the vehicle 12.

Associated with each one of the cameras 20-22 is a mirror assembly 40 (FIGS. 2-5). Each mirror assembly 40 includes a housing 42, a mirror support 44, an end cap 46, and a mirror 48. The mirror assembly 40 that is associated with the left rear camera 20 is described below in detail; the mirror assembly 40 for the right rear camera 22 is similar in construction and operation.

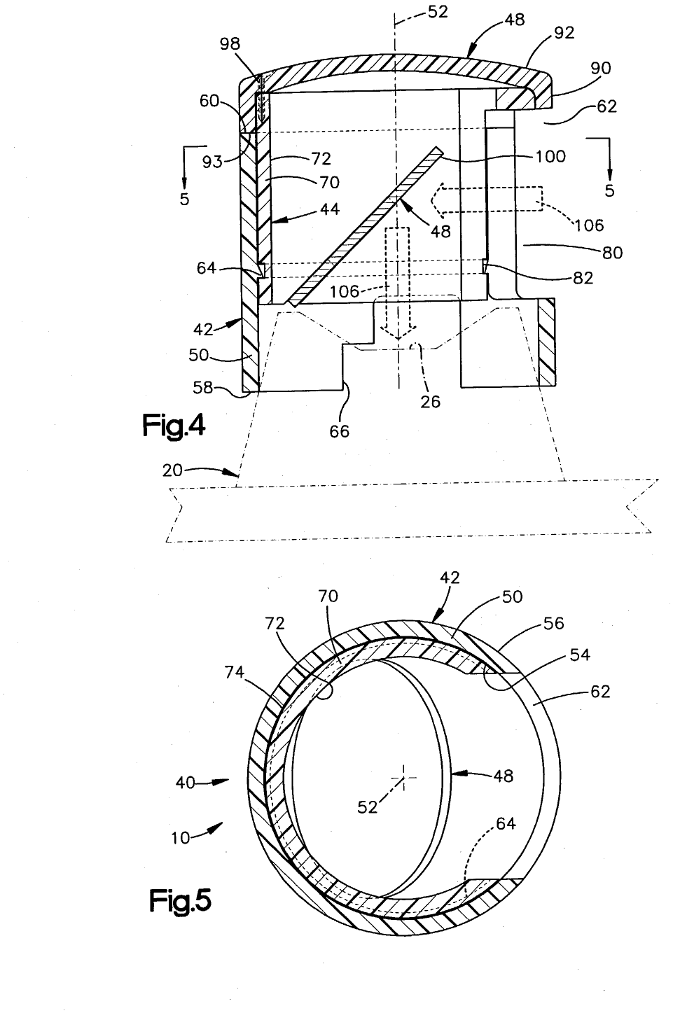

The housing 42 of the mirror assembly 40 has a tubular, generally cylindrical open-ended configuration including a cylindrical side wall 50 centered on a longitudinal central axis 52 of the mirror assembly. The side wall 50 has parallel, cylindrical, inner and outer side surfaces 54 and 56 (FIG. 5). The side wall 50 also has annular, radially extending inner and outer end surfaces 58 and 60 (FIG. 4).

A portion of the side wall 50 is cut out to form a window 62. The window 62 in the illustrated embodiment extends from the outer end surface 60 for approximately two thirds of the length of the side wall 50. The window 62 has an angular extent of about ninety degrees.

An inwardly projecting rib 64 (FIGS. 3 and 4) extends circumferentially along the inner side surface 54 of the side wall 50. The rib 64 is interrupted by the window 62.

Another portion of the side wall 50 of the housing 42 is cut out to form a clearance opening 66. The clearance opening 66 in the illustrated embodiment extends from the inner end surface 58 for a small portion of the length of the side wall 50.

The side wall 50 of the housing 42 is secured to the camera 20. In the illustrated embodiment, this attachment is made by gluing the housing 42 to the window portion 24 of the camera 20; other methods could be used.

The mirror support 44 has a tubular, generally cylindrical configuration including a cylindrical side wall 70 centered on the axis 52. The side wall 70 has parallel, cylindrical, inner and outer side surfaces 72 and 74 (FIG. 5). The outer diameter of the side wall 70 of the mirror support 44 is the same as, or slightly smaller than, the inner diameter of the side wall 50 of the housing 42.

The mirror support 44 also has at one end a circular, radially extending outer end surface 76 (FIG. 3). The opposite inner end 78 of the mirror support 44 is open.

A portion of the side wall of the mirror support 44 is cut out to form a window 80. The window 80 in the illustrated embodiment extends from the end surface 76 for substantially the entire length of the side wall 70. The angular extent of the window 80 in the mirror support 44 is substantially the same as the angular extent of the window 62 in the housing 42. Thus, in the illustrated embodiment, the window 80 in the mirror support 44 has an angular extent of about ninety degrees.

A circumferential groove 82 (FIGS. 3 and 4) is formed in the outer surface 74 of the side wall 70 of the mirror support 44, near the inner end of the side wall. The groove 82 is interrupted by the window 80.

The mirror support side wall 70 is received in the housing side wall 50. The groove 82 in the mirror support side wall 70 rotatably receives the rib 64 on the housing side wall 50. As a result, the mirror support 44 is supported within the housing 42 for rotation relative to the housing about the axis 52. The engagement of the housing rib 64 in the mirror support groove 82 prevents the mirror support 44 from moving axially relative to the housing 42, for example, from coming out of the open end of the housing.

The mirror support 44 includes a mirror slot 84 (FIG. 3). The mirror slot 84 is formed in the inner side surface 72 of the side wall 70 of the mirror support 44. The mirror slot 84 extends at a forty-five degree angle to the axis 52 and is adapted to receive a circular mirror as described below. The mirror slot 84 extends from the inner end 78 of the side wall 70 of the mirror support 44 for a portion of the length of the side wall.

The end cap 46 has a cylindrical side wall 90 and an end wall 92. The side wall 90 of the end cap 46 is substantially the same diameter as the side wall 50 of the housing 42. The side wall 90 of the end cap 46 has an annular, radially extending end surface 93 (FIG. 4). A portion of the side wall 90 is cut out to form a window 94. The window 94 preferably has the same angular extent as the window 80 in the mirror support 44.

Three fastener openings 96 are formed in the end wall 92 of the end cap 46. Three fasteners 98 extend through the fastener openings 96 in the end wall 92 of the end cap 46, into the mirror support 44. The fasteners 98 secure the end cap 46 to the mirror support 44 and, thereby, to the housing 42 and to the camera 20. When the end cap 46 is thus secured to the mirror support 44, the end surface 93 of the side wall 90 of the cap abuttingly engages the outer end surface 60 of the side wall 50 of the housing 42. The end cap 46 is thus fixed for rotation with the mirror support 44, relative to the housing 42 and the camera 20, about the axis 52.

The mirror assembly 40 includes at least one reflective surface 100 associated with the camera 20. The reflective surface 100 in the illustrated embodiment is shown as being included in the mirror 48. The mirror 48 includes a substrate, such as glass, metal or plastic. The reflective surface 100 is formed on the front of the substrate, not the back, to prevent absorption of infrared energy by the substrate.

The mirror 48 could be of a different construction than as illustrated and described. The mirror 48 could be a glass or plastic element, or a metal element, for example. In addition, the reflective surface 100 could be located on an element other than a mirror. For convenience, the term “mirror” is used herein to mean any reflective surface on any object suitable in this application.

The mirror 48 is positioned and oriented so that it is located in the optical path between the camera window 26 and the window 80 on the mirror support 44. Specifically, the mirror 48 is a circular mirror that is received in the mirror slot 84 in the mirror support 44. The mirror 48 is oriented so that infrared energy that enters the mirror support 44, through the window 80, contacts the mirror 48 before it contacts the window 26 of the camera 20. The infrared energy bounces off the mirror 48 and to the camera 20. When the infrared energy bounces off the mirror 48, the image that the energy represents, or carries, is reversed.

The mirror 48 is rotatable with the mirror support 44 relative to the housing 42. The mirror 48 also preferably is heated. Specifically, a resistive element or other type of heating device, shown schematically at 102, is located on the camera 20. The heating device 102 is selectively actuatable by vehicle electric circuitry (not shown) to heat the camera window 26 and the mirror 48 and thereby to disperse snow or frost or moisture from the reflective surface 100. This can help to keep the reflective surface 100 clean and thereby provide a clean image of the area being viewed.

The mirror assembly 40 and camera 20 are preferably mounted on the vehicle 12 so that the window 80 in the mirror support 44 faces generally rearward, in the direction of the outside area to be imaged. Thus, the camera window 26 itself does not face in the direction of the outside area to be imaged.

Infrared energy that is emitted by or reflected from objects in the field of view of the camera 20, as represented by the arrows 106, is directed by the window 62 in the housing 42 and by the window 80 in the mirror support 44, into the interior of the mirror assembly 10. The infrared energy 106 contacts the mirror 48, is reflected by the reflective surface 100, and is thereby directed to the window 26 of the camera 20. The infrared energy 106 is an image of the exterior area of the vehicle 12 that is in the field of view 104 of the camera 20. This image is reversed when it is reflected by the mirror 48, in a left-to-right direction.

This image is displayed on the left rear display area 34 of the LCD screen 30. When the image is displayed, the image that is seen replicates the view through a rear view mirror because it is reversed in a left-to-right direction. This can be advantageous to a driver who is already seeing a reversed image in a standard rear view mirror.

When the camera 20 is thus mounted on the vehicle 12, selection of the vertical location or height of the area to be imaged can be made by rotating the mirror 48. Specifically, the subassembly of the mirror 48, mirror support 44, and end cap 46 is rotated relative to the housing 42 about the axis 52. As a result, the mirror assembly 10 and the camera 20 can “see” in different vertical directions with a field of view indicated schematically at 104 in FIG. 1.

From the above description of the invention, those skilled in the art will perceive improvements, changes, and modifications in the invention. Such improvements, changes, and modifications within the skill of the art are intended to be included within the scope of the appended claims.

Having described the invention, we claim:

1. An apparatus for displaying an image of an area outside a vehicle, said apparatus comprising:
a camera for mounting on a vehicle at a location adapted for taking an image of an area outside the vehicle;
a mirror for mounting on the vehicle at a location between the camera and the area being imaged whereby the image of the area is reversed in a left to right direction when received at the camera; and
an electronic display device having a display area for displaying the reversed image.

2. An apparatus as set forth in claim 1 wherein said camera is an infrared camera and said mirror is adapted to reflect infrared energy without absorption by a substrate.

3. An apparatus as set forth in claim 1 wherein said mirror is selectively movable relative to said camera to vary the field of view of said camera.

4. An apparatus as set forth in claim 3 wherein said mirror is rotatable relative to said camera about an axis.

5. An apparatus as set forth in claim 1 further including a heater for heating said mirror.

6. An apparatus as set forth in claim 1 including a housing supported on said camera, said housing supporting said mirror relative to said camera, said housing including a first portion fixed to said camera and having a window, and a second portion movable relative to said first portion and having a second window.

7. An apparatus as set forth in claim 6 wherein said second portion of said housing supports said mirror in position relative to said camera.

8. An apparatus as set forth in claim 7 wherein said second portion of said housing supports said mirror for rotational movement relative to said camera.

9. An apparatus for displaying an image of an area outside the rear of a vehicle in a manner replicating the view from a rear view mirror, said apparatus comprising:
an infrared camera for mounting on the vehicle at a location adapted for taking an infrared image of a rear area outside the vehicle, said camera having a camera window for receiving infrared energy in the form of an infrared image;
a mirror assembly supported on said camera, said mirror assembly having a window for receiving infrared energy;
a mirror supported in said mirror assembly at a location between said housing window and said camera window whereby an infrared image passing into said mirror assembly through said housing window is reversed in orientation in a left to right direction when it contacts said camera window; and
an electronic display device having a display area for displaying the reversed rear image.

10. An apparatus as set forth in claim 9 wherein said mirror comprises a substrate having a reflective surface on the front of said substrate.

11. An apparatus as set forth in claim 9 wherein said mirror is rotatable about an axis relative to said camera to change the field of view of said camera.

12. An apparatus as set forth in claim 9 wherein said mirror assembly includes a housing and a mirror support, said housing being fixed to said camera, said mirror support supporting said mirror on said housing for rotation relative to said housing.

13. An apparatus as set forth in claim 12 wherein said housing includes a window adjacent said mirror and said mirror support includes a window co-extensive with said window in said housing for directing infrared energy to said mirror.

14. An apparatus for displaying an image of the area outside the rear of a vehicle in a manner replicating the view from a rear view mirror, said apparatus comprising:
a first camera for mounting on the vehicle at a location adapted for taking an image of a left rear area outside the vehicle;
a first mirror for mounting on the vehicle at a location between the first camera and the left rear area being imaged whereby the left rear image is reversed in a left to right direction when received at the first camera;
a second camera for mounting on the vehicle at a location adapted for taking an image of a right rear area outside the vehicle;
a second mirror for mounting on the vehicle at a location between the second camera and the right rear area being imaged whereby the right rear image is reversed in a left to right direction when received at the second camera;
a display screen having at least two display areas including a left rear display area and a right rear display area;
electric circuitry for directing the reversed left rear image from said first camera to said left rear display area of said display screen and for displaying the reversed left rear image; and
electric circuitry for directing the reversed right rear image from said second camera to said right rear display area of said LCD screen and for displaying the reversed right rear image.

15. An apparatus as set forth in claim 14 wherein each one of said left and right mirrors is rotatable relative to its associated camera to vary the field of view of the camera.

16. An apparatus as set forth in claim 14 wherein each one of said left and right mirrors comprises a substrate having a reflective surface on the front of said substrate.

17. An apparatus as set forth in claim 14 including first and second mirror assemblies associated with said first and second cameras, respectively, said first and second mirror assemblies including said first and second mirrors, each one of said first and second mirror assemblies including a housing and a mirror support, said housing being fixed to said camera, said mirror support supporting said mirror on said housing for rotation relative to said housing, each one of said housings including a window adjacent said mirror and each one of said mirror supports including a window co-extensive with said window in said housing for directing infrared energy to said mirror.
